(19) United States
(12) Patent Application Publication
(10) Pub. No.: US 2013/0045241 A1
(43) Pub. Date: Feb. 21, 2013

(54) STABILIZED AQUEOUS DISPERSION OF FOLPET ANALOGUES, METHOD OF PREPARING THE SAME AND COMPOSITION THEREOF

(71) Applicants: Raman Premachandran, Saddle Brook, NJ (US); Daniel H. Brown, Carteret, NJ (US); Blanca Gomez, Phillipsburg, NJ (US); Karen Winkowski, Springfield, NJ (US)

(72) Inventors: Raman Premachandran, Saddle Brook, NJ (US); Daniel H. Brown, Carteret, NJ (US); Blanca Gomez, Phillipsburg, NJ (US); Karen Winkowski, Springfield, NJ (US)

(73) Assignee: ISP Investments Inc., Wilmington, DE (US)

(21) Appl. No.: 13/513,084

(22) PCT Filed: Dec. 7, 2010
(86) PCT No.: PCT/US10/59227

§ 371 Date: Oct. 5, 2012

Related U.S. Application Data
(60) Provisional application No. 61/267,123, filed on Dec. 7, 2009.

(51) Int. Cl. A01N 43/38; A01P 3/00; A01N 25/00

(52) U.S. Cl. 424/400; 514/418

(57) ABSTRACT

An aqueous dispersion having a mixture of a hydrolysis-sensitive biocide, an iodo-derived hydrophobic biocide and an inert carrier dispersed in water. The iodo-derived hydrophobic biocide forms a complex with the inert carrier and the hydrolysis-sensitive biocide that is dispersible in water. The hydrophobic coating includes an inert carrier and the hydrolysis-sensitive biocide may be trihalogenomethylthio phthalimide or an analogue thereof and the iodo-derived hydrophobic biocide may be iodopropynyl butylcarbamate. The aqueous dispersion may also include a water-repelling layer coating the complex.

### FIELD OF THE INVENTION

This invention relates to biocides, more particularly, to aqueous dispersions of hydrolysis-sensitive biocides, such as Folpet or analogues thereof.

### BACKGROUND OF THE INVENTION

Folpet, a chloroalkylthio compound with broad spectrum protectant fungicide (N-(trichloromethylthio) phthalimide, has been in use for the last several decades. Folpet is predominantly used in agronomic practice along with other industrial applications today.

Captan, Folpet, Fluorofolpet, Tolyfluanid, Dichlofluanid are unstable in aqueous solution, but their rate of hydrolysis is slow compared to their reaction with thiols. The reason for their fungicidal activity is the balance between the reactivity of the trichloromethylthio moiety and the stability of the nitrogen-sulfur bond linking this moiety to the imide ring. Analogs with very stable bonds prove to be ineffective fungicides, whereas analogs with bonds that are overly labile degrade spontaneously (Horsfall, J. G., and Rich, S. Phytopathology 47, 17, 1957; Lukens, R. J. J. Agric. Food Chem. 14(4), 365-367. 1966). The hydrolytic and thiol reactions serve to degrade the parent molecule and thus influence the toxicological outcome. Folpet (I) is hydrolyzed to give phthalimide (II) and thiophosgene (III). Then, phthalimide (II) is further hydrolyzed to phthalamic acid (IV), which is self hydrolyzed to give phthalic acid (V).

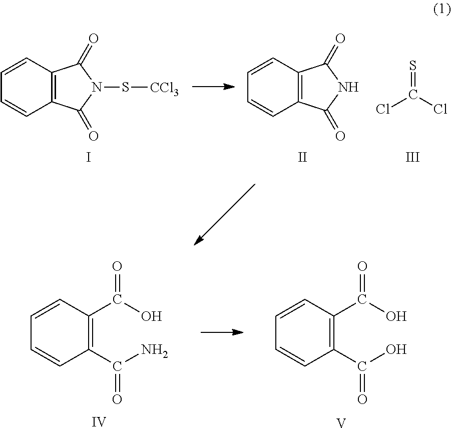

Folpet has low water solubility or is practically insoluble in water and only slightly soluble in organic solvents. Further, the rates of aqueous hydrolysis increase in alkaline conditions and are more rapid for Folpet analogues. The higher hydrolytic rates for Folpet analogues are related to the higher standard free energy of the phthalimide ring structure. The half-life of the majority of these compounds in aqueous system is from a few minutes to hours at alkaline to neutral pH ranges which are a favorable delivery medium for numerous industrially applicable formulations or compositions.

The hydrolysis-sensitive property of Folpet and Folpet analogues limits their utility in water based industrial products and their application alone or in combination with other antimicrobial agents. This property also compels them to be delivered through forms such as powder, emulsifiable concentrate and solvent dispersion. Unfortunately, these forms are difficult to handle and more non-eco friendly than an aqueous formulation.

U.S. Patent Publication No. 2002/0055566 discloses aqueous systems comprising at least one hydrolysis-sensitive active compound in combination with binders which consist of alkyd resins based on vegetable oils and or acrylate dispersions. The aqueous systems or ready-to-use formulation with fungicidal activity is particularly aimed at tolylfluanid and its storage stability is demonstrated in water-based wood preservatives. The disclosed formulations are limited to compositions having pH ≦7.

### SUMMARY OF THE INVENTION

What is described herein is a stable, solvent-free, aqueous dispersion composition of hydrolysis-sensitive biocide such as trihalogenomethylthio phthalimide biocides, for example, Folpet and Folpet analogues. The hydrolysis sensitive biocide is present in a mixture of finely divided particles with an iodo-derived hydrophobic biocide such as iodopropynyl butylcarbamate (IPBC) and an inert carrier. The aqueous dispersion may also include and one or more additives.

In one embodiment, aqueous dispersions are disclosed that have a mixture of a hydrolysis-sensitive biocide, an iodo-derived hydrophobic biocide and an inert carrier dispersed in water. The iodo-derived hydrophobic biocide forms a complex with the inert carrier and the hydrolysis-sensitive biocide that is dispersible in water. The hydrophobic coating includes an inert carrier and the hydrolysis-sensitive biocide may be trihalogenomethylthio phthalimide or an analogue thereof and the iodo-derived hydrophobic biocide may be iodopropynyl butylcarbamate.

The inert carrier may be selected from ground natural minerals, ground synthetic minerals, metal oxides, and combinations thereof. In one embodiment, the inert carrier includes at least one of a clay, talc, chalk, quartz, attapulgite, montmorillonite or diatomacious earth, perlite, zeolite, highly-disperse silica, alumina, titanium dioxide and silicates. In another embodiment, the inert carrier includes a metal oxide and a silica.

The aqueous dispersion may also include a water-repelling layer coating the complex.

In one embodiment, the pH of said aqueous dispersion is between about 7.0 to about 11.0. In another embodiment, the pH is at least about 8.0.

In one embodiment, the wt. % ratio of trihalogenomethylthio phthalimide analogue:IPBC is from about 0.1:9.9 to about 9.9:0.1 in the composition.

In another aspect a process for preparing a stable, solvent-free, aqueous dispersion composition of hydrolysis-sensitive biocide is disclosed. The process includes (a) preparing a dry blend of particles comprising a mixture of a hydrolysis-sensitive biocide, an iodo-derived hydrophobic biocide, and an inert carrier to form a complex, (b) mixing the complex with water containing at least one of a dispersant, grind aid, and a thickener, and (c) mechanically processing the mixture from step (b) to yield a desired mean particle size. The process may also include the step of coating the complex with a water-repelling agent.

In another embodiment, the additives for preparing the desired composition can be a wetting agent, suspending agent, water repelling agent, preservative, algaecide, anti-microbial or silicon fluid alone or in combination thereof. Further, the inert carrier is selected from the group comprising ground natural minerals, ground synthetic minerals and/or metal oxides.

In accordance with further aspect of the present invention, of the aqueous dispersion composition prepared according to the said process containing the stable, hydrolysis-sensitive Folpet/analogues is employed in the field of paint, building materials, stucco, concrete, caulks, sealants, joint compounds, adhesives, leather, wood, inks, pigment dispersions, metal working fluids, drilling mud and/or clay slurries.

### DETAILED DESCRIPTION OF THE INVENTION

While this specification concludes with claims particularly pointing out and distinctly claiming that which is regarded as the invention, it is anticipated that the invention can be more readily understood through reading the following detailed description of the invention and the examples.

The term “about” can indicate a difference of 10 percent of the value specified. Numerical ranges as used herein are meant to include every number and subset of numbers enclosed within that range, whether particularly disclosed or not. All percentages, parts, proportions and ratios as used herein, are by weight of the total composition, unless otherwise specified. If not indicated otherwise, “%” means “% by weight”.

The term “Folpet analogues” and “trihalogenomethylthio phthalimide analogues” are synonymously used throughout this application.

As used herein, the term “hydrolysis-sensitive” means the ability of a compound or substance to undergo a chemical reaction that breaks down the compound or substance, typically into two parts, by the additional H₂0, which may lead to an unwanted degradation product.

The term “solvent-free,” as used herein is referring to a composition of matter, designates that no external solvent constituent has been added in the present aqueous dispersion composition during the process of making the composition. However, the composition may include about 5% or less residual solvent, more preferably 1% or less residual solvent. One of skill in the art will appreciate that residual solvents may be present inherently in commercially available or synthesized products which may or may not be part of the aqueous dispersion composition of the present invention and wherein the inherent presence of residual solvent is not precluded by use of the term “solvent-free.”

The patents and publications referred to herein are hereby incorporated by reference to the extent necessary to understand the present invention.

Disclosed herein are methods and formulations to stabilize hydrolysis-sensitive Folpet analogues through finely ground mixtures of at least one of Folpet (and/or its analogues) and iodopropynyl butylcarbamate (IPBC) in the presence of additives including clay, titanium dioxide and/or silicon fluid that is dispersed in an aqueous medium. The pH of the aqueous medium may be about 8 and results in a stable aqueous dispersion composition of the biocide. The biocide(s) as a result of the dispersion process may include a hydrophobic coating thereon that enhances the longevity of the biocides in the aqueous medium, i.e., hydrolysis or the rate of hydrolysis of the hydrolysis-sensitive biocide is reduced.

Without being bound by theory, it is considered that the stabilization of trihalogenomethylthio phthalimide compounds and IPBC is possible through strong physico-chemical complex among these organic molecules. It is believed that the best long term stability is obtained at the molar ratio 1:1 of IPBC:trihalogenomethylthio phthalimide compounds.

In one embodiment, the preferred hydrolysis-sensitive biocides would include but are not limited to compounds having a functional group of —N—S—CX₃ or —N—S—CCl₂X and wherein X is any halogen, for example Cl or F, or CH₂X₂, wherein X is a halogen. The specific hydrolysis-sensitive trihalogenomethylthio compounds can be selected from Captan, Captafol, Dichlofluanid, Tolyfluanid, Folpet and/or Fluorofolpet.

The aqueous stabilization of the hydrolysis-sensitive trihalogenomethylthio phthalimide analogues is also carried out by employing other iodo derived compounds apart from IPBC which would include iodoalkynyl compounds or compounds wherein one or more iodine atoms are attached to double or triple bond systems, or compounds in which one or more iodine atoms are attached to singly bonded carbon atoms. Non-limiting iodine-containing active compounds include: 3-iodo-2-propynylpropyl carbamate, 3-iodo-2-propynylbutyl carbamate (IPBC), 3-iodo-2-propynyl-m-chlorophenyl carbamate, 3-iodo-2-propynylphenyl carbamate, 3-iodo-2-propynyl 2,4,5-trichloro-phenyl ether, 3-iodo-2-propynyl 4-chlorophenyl formal (IPCF), di(3-iodo-2-propynyl)hexyl dicarbamate, 3-iodo-2-propynyloxyethanol ethylcarbamate, 3-iodo-2-propynyloxyethanol phenyl carbamate, 3-iodo-2-propynylthioxothioethyl carbamate, 3-iodo-2-propynylcarbamic ester (IPC), N-iodpropargyloxycarbonylalanine, N-iodopropargyloxycarbonylalanine ethyl ester, 3-(3-iodo-propargyl)benzoxazol-2-one, 3-(3-iodopropargyl)-6-chlorobenzoxazol-2-one, diiodomethyl p-tolyl sulphone, diiodomethyl p-chlorophenyl sulphone, 3-iodo-2-propynyl alcohol, 4-chlorophenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propynyl n-hexylcarbamate, 3-iodo-2-propynyl cyclohexylcarbamate.

In one embodiment, finely divided particles of at least one of trihalogenomethylthio phthalimides and IPBC are obtained through known mechanical processing methods such as, but not limited to, pulverizing, crushing, grinding and/or milling methods in order to achieve the resultant mixture of particles. The particles may have a particle size of less than about 0.5 μm to about 10.0 μm and preferably about 0.5 μm to about 3.0 μm. In one embodiment, the particle size reduction is carried out in mills, such as, for example, ball mills, agitator ball mills, circulating mills (agitator ball mills with pin grinding system), disk mills, annular chamber mills, double cone mills, triple roll mills and batch mills. To dissipate the heat energy introduced during the grinding process, the grinding chambers are preferably fitted with cooling systems.

Grinding or milling media useful for the preparation of the finely ground mixture includes, but is not limited to, steel shots, carbon steel shots, stannous steel shots, chrome steel shots, tungsten carbide, silicon nitride, silicon, carbide, ceramic, zirconium based media including zirconia, zirconium silicate, zirconium oxide, stabilized zirconia such as yttrium stabilized zirconia, calcium stabilized zircona, magnesium stabilized zirconia, cerium stabilized zirconia, stabilized magnesium oxide, stabilized aluminum oxide and the like.

The finely divided particles of the mixture of trihalogenomethylthio phthalimide and IPBC may be further mixed with an inert carrier, more particularly a hydrophobic inert carrier. The IPBC adsorbs onto the other particles, including the trihalogenomethylthio phthalimide to form a water insoluble complex. It is believed that the complex improves the hydrolytic stability of the trihalogenomethylthio phthalimide and a combination biocide efficacy. Examples of suitable inert carriers are discussed below. In another embodiment, the hydrolytic stability is further improved by coating the complex with a water repellant layer.

The inert carrier may be selected from the group consisting of finely ground natural minerals, ground synthetic minerals and/or metal oxides and preferably selected from the group consisting of clays, talc, chalk, quartz, attapulgite, montmorillonite or diatomaceous earth, perlite or “expanded perlite”, zeolite including microphorous aluminosilicate, highly-disperse silica, alumina, mica, wollastonite, silicate or aluminosilicate. Clay minerals of kandite group, for example kaolinite, dickite, nacrite and halloysite, have been found to be particularly advantageous. “Kaolinite” includes kaolin type clays, ball clays, fire clays and China clays. Such clays occur in nature in the form of kaolinite plus other minerals, eg. one or more of illite, mica, quartz and feldspar. The kaolinite clay mineral may be used in its natural, hydroxylated or hydrous state. Wherein the aluminosilicate comprises of smectite clay, it may comprise for example one or more of bentonite, hectorite and saponite. The silicates may be oxidized silicon compounds such as SiO₃, SiO₄, Si₂O₆ and Si₂O₇.

In one embodiment, the inert carriers is a silicate clay, for example, an aluminosilicate clay. In one embodiment, aluminosilicate clay is a kaolin clay composed of the mineral kaolinite, an aluminosilicate and is a hydrated silica of alumina with a composition of about 46% silica, about 40% alumina and about 14% water. Examples of suitable kaolin clay particles are KaMin™ 80 clay, KaMin™ 90 clay, Polygloss® 80 clay and Polygloss® 90 clay. Other suitable examples of natural refined kaolin clay are DixieClay® fillers, Par® clay fillers and Bilt-Plates® 156 clay fillers from R.T. Vanderbilt Company, Inc.

In another embodiment, the inert carrier is a metal or metal compound selected from one or more of the groups IIIB, IVB, VB, VIB VIIB or VIIIB of the Periodic Table. The metal or metal compounds may be employed in the form of salts, colloidal metal oxides, aluminates, silicates, titanates, zincate, zirconates, zircoaluminate, aluminium titanate, aluminium silicate, stannates or argentates of aluminum, silicon, titanium, zirconium or copper, cobalt, cadmium, nickel, tin, silver, zinc, lead, bismuth, chromium, manganese, iron or arsenic alone or in combination thereof. In one embodiment the inert carrier is or includes titanium dioxide, which may be present in a concentration of 0.01% to 10%, or from 1.0% to 5.0%.

After the biocides are mechanically processed into a desired particle size and adsorbed into a complex with the inert carrier, the complex may be coated with a water-repelling agent. The water-repelling agent provide a coating that makes it more difficult for water to interact with the hydrolysis-sensitive biocide. In one embodiment, the water-repelling agent may be a film forming polymer. The water-repelling film forming polymer may be or include, but is not limited to, poly(acrylic), poly(methacrylics), poly(vinyl ether), poly(vinyl ester), polystyrene, polyurethane, polyoxide, polycarbonate, cellulose ester, cellulose ether, polyester, vinyl pyrrolidone copolymers like alkyl grafted PVP (Ganex®/Agrimer® AL 30, 22, 25, WP 660 polymers) Agrimer® VA PVP-vinyl acetate copolymers, alkylated polyvinylpyrrolidone-hexadecane copolymer, polydiemethyl silane, beeswax and alkyl vinyl ether-maleic acid half-ester polymers, polyvinyl alkyl ether, polyacrylate-polyoctylacrylamide copolymer (Dermacryl®79 and Dermacryl® LT), a copolymer of a vinyl alkyl ether with vinyl acetate or vinyl chloride, methylcellulose, cellulose acetate, cellulose acetate butyrate, cellulose acetate phthalate, polyvinyl butyral, polyvinyl acetate, polymethyl methacrylate and polystyrene, vinyl homopolymers, acrylate homopolymers, styrene/butadiene copolymers, stryene/acrylate copolymers, or styrene/butadiene/acrylate copolymers, an acrylate ester polymer for example a homopolymer or copolymer of one or more alkyl acrylates or methacrylates which preferably contain 1 to 6 carbon atoms in the alkyl group and may contain a co-monomer such as acrylonitrile or styrene, or a vinyl acetate polymer such as polyvinyl acetate or a vinyl acetate vinyl chloride copolymer, fluorochemical polymers, styrene maleic anhydride copolymers, polyalkylsiloxanes, polydimethylsiloxane, (acrylamidomethyl)cellulose acetate butyrate, (acrylamidomethyl)cellulose acetate propionate. Condensation polymers include, for example, polyesters, polyamides, polyurethanes, polyureas, polyethers, polycarbonates, polyacid anhydrides, and polymers comprising combinations of the above-mentioned types. Addition polymers are polymers formed from polymerization of vinyl-type monomers including, for example, allyl compounds, vinyl ethers, vinyl heterocylic compounds, styrenes, olefins and halogenated olefins, unsaturated acids and esters derived from them, unsaturated nitrites, vinyl alcohols, acrylamides and methacrylamides, vinyl ketones, multifunctional monomers, or copolymers formed from various combinations of these monomers. Long chain film forming amines may also be used for this purpose.

Other suitable polymers for coating the particles include natural rubber, prevulcanized natural rubber, butyl rubber, isobutene-isoprene copolymers, polyisoprene, polybutadiene, acrylonitrile-butadiene copolymers, stryrene-butadiene copolymers, chloroprene rubber, polyvinylacetate, vinyl acetate copolymerized with one or more vinyl esters of an alkanoic acid, acrylates and/or olefinic hydrocarbons, acrylics (i.e., homopolymers or copolymers of alkyl acrylates, alkyl methacrylates, acrylic acid and/or methacrylic acid), polyurethanes, polyvinylidene chloride, polyvinyl chloride, vinyl chloride-vinylidene chloride copolymers, polyvinylidene fluoride, blends of ployvinylidene fluoride and acrylics, ethylene-vinylacetate copolymers, polyvinyl chloride (PVC) (and co and terpolymers thereof), styrene-butadiene rubber (SBR), styrene-butadiene block copolymers (SBS), styrene-isoprene-styrene copolymers (SIS), styrene-ethylenebutylene-styrene block copolymers (SEBS) and mixtures thereof. These polymers can be prepared by emulsion polymerization, solution polymerization, suspension polymerization, dispersion polymerization, ionic polymerization (cationic, anionic), Atomic Transfer Radical Polymerization, and other polymerization methods known in the art of polymerization.

The coating on the finely divided particles may also provide enhanced storage-protection. The coating may be applied by various methods, including any conventional coating method. Suitable non-limiting coating methods include brushing, dip-coating, flowing and spraying. Spraying methods may include conventional techniques such as compressed air spraying, electronic spraying, and other manual or automatic methods known to one of skill in the art. Once applied to a mixture, the coating compositions can be cured at ambient or elevated temperatures.

In order to prepare the aqueous dispersions, the aqueous medium can be any type of water including, but not limited to, distilled water, de-ionized water, double distilled water, triple distilled water, tap water, de-mineralized water, reverse-osmosis water and combination thereof.

The aqueous dispersions, because of the inclusion of a biocide, provide potent activity against various microorganisms, hence the following non-limiting genera of microorganisms are preferably specified herein as the interest of the present invention: Alternaria, such as Alternaria alternata Alternaria tenuis, Aspergillus, such as Aspergillus niger and Aspergillus terreus, Aureobasidium, such as Aureobasidium pullulans, Chaetomium, such as Chaetomium globosum, Cladosporium, such as Cladosporium herbarum, Coniophora, such as Coniophora puteana, Gliocladium, such as Gliocladium virens, Lentinus, such as Lentinus tigrinus, Paecilomyces, such as Paecilomyces varioti, Penicillium, such as Penicillium brevicaule, Penicillium glaucum and Penicillium pinophilum, Polyporus, such as Polyporus versicolor, Sclerophoma, such as Sclerophoma pityophila, Streptoverticillium, such as Streptoverticillium reticulum, Trichoderma, such as Trichoderma viride and Trichophyton, such as Trichophyton mentagrophytes; Escherichia, such as Escherichia coli, Pseudomonas, such as Pseudomonas areuginosa, and Staphylococcus, such as Staphylococcus aureus; and Candida, such as Candida albicans.

Various other compounds or additives may be added to the aqueous dispersions to enhance or obtain desired properties. The additives include, but are not limited to, antifoams, plasticizers, surfactants, suspending agents, wetting agents, fillers, coloring agents, dispersing agents, thickening agents, thixotropic agents, antifreezing agents, pH adjusting agents, silicon fluid, corrosion inhibitors, ultraviolet light stabilizers, antioxidants, algaecide, preservative, antimicrobial agents and the like.

Accordingly, the aqueous dispersions may include a thickening agent. The thickening agent, preferably is one that can provide dispersal of the ingredients of the composition in a uniform manner. Further, the thickening agent may be one that enhances the viscosity of the dispersions without modifying its original properties, which may also increase the stability thereof. In one embodiment, the thickening agent may be a hydrocolloid gums such as xanthan gum, guar gum, gellan gum, locust bean gum, gum arabicand alginates, which impart thixotropic properties to the dispersion. In another embodiment, cellulose thickening agents are employed. The cellulose thickening agents may be or include, but are not limited to, hydroxypropyl cellulose, hydroxyethyl cellulose, hydroxypropylmethyl cellulose, ethyl hydroxyethyl cellulose, methyl ethyl hydroxyethyl cellulose, hydroxymethyl cellulose, hydroxyethylmethyl cellulose, carboxymethyl cellulose, sodium carboxymethyl cellulose, microcrystalline cellulose, and combinations thereof. In another embodiment, hydrophilically modified ethoxylated urethane (HEUR) and/or hydrophobically modified ethoxylated urethane alkali swellable emulsions (HEURASE) are optional thickening agents. Other possible thickening agents include water-soluble gums as described in the Encyclopedia of Polymer Science and Engineering, vol. 7, pp. 589-613 (John Wiley & Sons, Inc. N.Y., N.Y. 1987), the disclosure of which is incorporated by reference.

Suitable commercial thickening agents include, but are not limited to, xanthan gums such as (Kelzan® xanthan gum or Vanzan D xanthan gum), Rhodopol®23 thickener (from Rhone Poulenc) or Veegum® thickener (from R.T. Vanderbilt), organic phyllosilicates such as Attaclay® thickener (from Engelhardt), HASE Thickener (RHEOLATE 425), ALCOGUM™ VEP-II (from Alco Chemical Corporation), RHEO VIS™ and VISCALEX™ (from Ciba Ceigy), UCAR®, ETHOCEL™ or METHOCEL™ (from The Dow Chemical Company) and PARAGUM™ 241 (from Para-Chem Southern, Inc.), or BERMACOL™ (from Akzo Nobel) or AQUALON™ (from Hercules) or ACUSOL® (from Rohm and Haas). The hydrophobically modified ethoxylated urethane (HEUR) thickeners such as Acrysol RM 1020, Acrysol RM2020 and Acrysol RM5000 available from Rohm and Haas. Various other HEUR thickener would include Borchi Gel 0434, Borchi Gel 0435 and Borchi Gel 0011, Borchi Gel 0620, Borchi Gel 0621, Borchi Gel 0622, Borchi Gel 0625, Borchi Gel 0626, Borchi Gel PW 25, Borchi Gel LW44, Borchi Gel 0024, Borchi Gel WN50S, Borchi Gel L75N, Borchi Gel L76 available from Borchers; Acrysol SCT-275, Acrysol RMB, Acrysol RM 825, Acrysol RM 895 Acrysol TT615 from Rohm and Haas; Tafigel PUR 40, Tafigel PUR 41, Tafigel PUR 50, Tafigel PUR 60 Tafigel PUR 61 available from Munzig; UCAR DR-73 available from Rohm and Haas, Aquaflow ALS 400 available from Aqualon; and the hydrophobically modified polyacetal polyether Aquaflow NLS 200, Aquaflow NLS 205, and Aquaflow NLS 210 available from Aqualon/Hercules.

The amount of thickening agent employed in the present aqueous dispersion composition will vary according to the nature and effectiveness of the thickening agent and the viscosity desired of the aqueous dispersions, but it may generally range between about 0.1% to about 10.0% based on the total weight of the composition, more particularly from about 0.1% to about 5.0%. The viscosity of the dispersions in absence of a thickening agent will be in the range of 10 to 100 centipoise (cp). The quantity of thickener will generally be sufficient to impart to the dispersion a viscosity greater than 100 cp, for example from about 150 cp to about 5,000 cp.

A “wetting agent” (surfactant) is a substance, which, at low concentrations, alter the interfacial tension and thus will stabilize the dispersion system or interacts between the surface of a particle and the surrounding liquid to improve dispersion. The organic surface-active material is preferably anionic, nonionic or ampholytic in nature. Wetting agents are amphipathic in structure having both polar and non-polar regions in the same molecule. Examples of surface active agents used in the formulation arts are given in Corrigan, O. I.; Healy, A. M. “Surfactants in Pharmaceutical Products and Systems” in Encyclopedia of Pharmaceutical Technology 2^{nd} ed. Taylor and Francis, 2006, pp 3583-3596.

Useful anionic surface active agents include sulfonic acid types, such as salts of alkanesulfonic acid, alphaolefinsulfonic acid, alkylbenzenesulfonic acid, alkylnaphthalenesulfonic acids, acylmethyltaurines, and dialkylsulfosuccinic acids, alkylsulfuric ester, sulfated oils, sulfated olefins, polyoxyethylene alkyl ether sulfuric ester salts, carboxylic acid types, e.g., fatty acid salts and alkylsarcosine salts and phosphoric acid ester types, such as alkylphosphoric ester salts, polyoxyethylene alkyl ether phosphoric ester salts, and glycerophosphoric ester salts.

Examples of water-soluble nonionic surfactants are condensation products of ethylene oxide with various reactive hydrogen-containing compounds reactive therewith having long hydrophobic chains (e.g. aliphatic chains of about 12 to 20 carbon atoms), which condensation products (“ethoxamers”) contain hydrophilic polyoxyethylene moieties, such as condensation products of poly(ethylene oxide) with fatty acids, fatty alcohols, fatty amides, polyhydric alcohols (e.g. sorbitan monosterate), polypropyleneoxide (e.g. Pluronic materials), poloxamers, polyoxyethylene sorbitan esters, fatty alcohol ethoxylates, alkylphenol ethoxylates, tertiary amine oxides, tertiary phosphine oxides and/or dialkyl sulfoxides. Suitable amphoteric surfactants include without limitation derivatives of C₈₋₂₀ aliphatic secondary and tertiary amines having an anionic group such as carboxylate, sulfate, sulfonate, phosphate or phosphonate.

In one embodiment, the aqueous dispersions contain an acetylene glycol surface active agent and/or an acetylene alcohol surface active agent to reduce the surface tension. The acetylene glycol may be 2,4,7,9-tetramethyl-5-decyne-4,7-diol, 3,6-dimethyl-4-octyne-3,6-diol, and 3,5-dimethyl-1-hexyn-3-ol. Suitable the commercially available acetylene glycol surface active agents include, but are not limited to Surfynol series 61, 104, 82, 440, 465, 485, TG and CT-111 CT-121, CT-131, CT211 agents available from Air Products and Chemicals, Inc., and Olfine series STG and E1010 These surface active agents are preferably used in amounts of 0.01 to 10% by weight, particularly 0.1 to 2% by weight, based on the total aqueous dispersion composition.

Suitable dispersing agent may be employed for the preparation of the aqueous dispersions, for example, cationic, amphoteric or nonionic compounds alone or in combinations thereof; however they are not limited to the dispersants that are described herein. Suitable examples are for instance described in C. R. Martens, Emulsion and Water-Soluble Paints and Coatings, Reinhold Publishing Corporation, 1965. The dispersants may be selected from tetra-potassium pyrophosphate or “TKPP” compounds such as Strodex™, Strodex™ PK-90, Strodex™ PK-0VOC, Strodex™ MOK-70 available from Dexter Chemical L.L.C. In some cases, a dispersant may be a particulate material supplied with trade name of Winnofil.® SPT Premium, Winnofil® S, Winnofil® SPM, and Winnofil® SPT available from Solvay Advanced Functional Minerals. A variety of preparations of customized montmorillonite clay dispersants (Bentone® clay) and castor wax under various trade names such as Crayvallac® SF, Crayvallac® MT, and Crayvallac®, AntiSettle CVP are available from Cray Valley Limited.

The dispersing agents can also be selected from standard organic polymeric dispersants known in the art for preparing aqueous dispersion compositions. For illustration, the dispersants may be polyelectrolytes such as polyacrylates and copolymers having polyacrylate compounds, for example various salts of polyacrylic acid compounds, sodium hexametaphosphates, polyphosphoric acid, condensed form of sodium phosphate, alkanolamines, and other reagents commonly used for this function. Exceptional dispersing agents would include poly(methylvinyl ether-co-maleic acid) partially neutralized with sodium hydroxide (EasySperse, EaseySperse P20 by ISP, Wayne N.J.) and non-ionic copolymers including but are not limited to EO/PO block copolymers or poloxamers such as Pluronics (for e.g. L101&P103) from BASF, polymers of acrylic and methacrylic acid, C₁₁-C₁₅ secondary ethoxylated alcohols and diols, PEG-PLGA-PEG copolymers and polyether polyols. Additional examples of suitable dispersants would include sodium silicate, sodium carbonate, lignosulphonic acid salts (e.g. Polyfon, Ufoxane or Marsperse), a sulfonated naphthalene/formaldehyde condensate (e.g. Morwet), a block copolymer with pigment affinic group (e.g. Disperbyck 190), 1,4 bis(2-ethylhexyl)sodiumsulfosuccinate (e.g. Triton GR PG 70), Polyether-polycarbonate sodium salt (e.g. Ethacryl P), maleic acid-olefin co-polymer (e.g. Vultamol NN 4501), ammonium polyacrylate (e.g. Dispex GA 40), C₆-C₁₅ secondary alcohol and alkyl aryl sulfonate (e.g. Zetasperse 2300) and alkyl naphthalene sulfonate (e.g. Agnique), henolsulphonic or naphthalenesulphonic acid salts, 2-amino-2-methyl-1-propanol, tri and tetra sodium salts of pyrophosphate and polyphosphate and water-soluble sodium or ammonium salts of polyacrylates, polycarboxylates and polymethacrylates.

Another object of the present invention is to provide a process for preparing a stable, solvent-free, aqueous dispersion composition of hydrolysis-sensitive biocide comprising the steps of:
i. preparing a dry blend of finely divided particles of mixture of IPBC, least one trihalogenomethylthio phthalimide analogue, and inert carrier;
ii. optionally coating the resultant mixture of (i) with one or more water repelling agents,
iii. preparing an aqueous medium comprising dispersed particles of mixture of wetting agent, partial amount of suspending and dispersing agent by means of milling/grinding with a suitable media to yield a desired mean particle size;
iv. combining the resultant dry blend of step (i) and aqueous medium of dispersed particles of step (iii) and milling/grinding the combined mixture for at least one hour employing a suitable media until the Hegmann number is more than 6.0; and
v. adding the residual quantity of aqueous medium and suspending agent to the resultant mixture obtained in the step (iii) and milling the final collective mixture to yield a stable aqueous dispersion.

The pH of the aqueous dispersion composition prepared according to the above procedure will be at least 7.0, and may be in the range of about 7.0 to about 11.0. In one embodiment, the pH may be between about 7.5 to about 8.5. In another embodiment, the pH may be at least 8.0 and may be between 8.0 to 10.5.

To provide the stable, solvent free, aqueous dispersion composition of Folpet/analogues, a silicone oil or fluid may be employed during preparation of the dispersion. The IPBC and Folpet/analogues are ground together in presence of suitable inert carrier and silicone fluid followed by dispersing the resultant mixture in aqueous media to provide the aqueous dispersion composition having pH of about 8.1 to form a stable aqueous dispersion. Further, suitable examples of silicone oils include, but are not limited to, dialkyl polysiloxane (e.g., hexamethyl disiloxane, tetramethyl disiloxane, octamethyl trisiloxane, hexamethyl trisiloxane, heptamethyl trisiloxane, decamethyl tetrasiloxane, trifluoropropyl heptamethyl trisiloxane, diethyl tetramethyl disiloxane), cyclic dialkyl polysiloxane (e.g., hexamethyl cyclotrisiloxane, octamethyl cyclotetrasiloxane, tetramethyl cyclotetrasiloxane, tetra(trifluoropropyl)tetramethyl cyclotetrasiloxane), and methylphenyl silicone oil. Particularly, the dimethyl polysiloxane is typically obtained commercially as silicone oil which is added to the blend of other constituents and ground together to form the final dispersion composition and wherein dimethyl polysiloxane from Dow Corning sold under the trademark 200 FLUID or from General Electric sold under the trademark SF96 polydimethylsiloxane fluid.

Preservatives of conventional types may be added to the present aqueous dispersion composition of the present invention to extend the shelf life of the composition. The preservative may serve as bactericide and a fungicide. Addition of preservatives is often appreciated, because various organic thickening agents are sensitive to microbial attack and can be stabilized by presence of suitable preservatives.

Preservative compounds such as formaldehyde donor compounds, phenolic compounds, isothiazolinones, parabens, benzoates, aldehydes, hydroxybenzoic acid esters, bicyclic oxazolidones can be employed. Suitable preservative compounds for the present composition include, but are not limited to, 2-methyl-4-isothiazolin-3-one (MIT), 1,2-Benzisothiazolin-3-one (BIT), 5-Chloro-2-methyl-4-isothiazolin-3-one (CMIT), methyl p-hydroxybenzoate, glutaraldehyde, 2-bromo-2-nitropropane-1,3-diol (bronopol, benzyl alcohol, diazolidinyl urea, imidazolidinyl urea, methyl paraben, ethyl paraben, phenoxy ethanol, propyl paraben, sodium methyl paraben, sodium ethyl paraben, sodium dehydroacetate, polyhexamethylenebiguanide hydrochloride, formaldehyde or hexahydrotriazine derivatives, and formaldehyde donors (Nuosept 95, Nuosept 91, Nuosept 101).

In accordance with the present invention, an algaecide can be incorporated into the aqueous dispersion to prevent any possibility of formation of algae and wherein the suitable algaecide compounds are selected from non-limiting examples of algaecides such as terbutylazine, copper sulfate, dichlorophen, endothal, fentin acetate, quinoclamine, quinonamid, irgarol, diuron, terbutryn, oxfluorfen, simmazine, and/or DCOIT.

In addition, the dispersion according to the invention optionally comprises one or more other biocidal active ingredients in order to enhance the composition activity and wherein said biocide would include one or more of insecticides, acaricides, algicides, molluscicides, biocides, bactericides, herbicides, plant growth regulators, fungicides and the like. Addition of these biocide compounds to the present dispersion system yields increased activity and spectrum.

The aqueous dispersion compositions disclosed herein are suitable for protecting industrial materials and wherein the industrial materials in the present context are non-living materials which have been prepared for use in industry. Aqueous dispersions of the present invention can be employed in the following non-limiting fields such as paint, building materials, stucco, concrete, caulks, sealants, joint compounds, adhesives, paper, card, textiles, coating materials and plastic articles, cooling lubricants, cooling water circulations, leather, wood, inks, pigment dispersions, metal working fluids, aqueous hydraulic fluids, drilling mud, and/or clay slurries those may be attacked or decomposed by microorganisms.

The following examples are given herein for illustration of the invention and are not intended to be limiting thereof.

### Example 1

| Component | Wt. % (in range) |
|---|---|
| Water | 44.5-69.3 |
| Surfynol ® CT 111grind aid | 0.5-0.9 |
| TiO₂ | 3.0-5.0 |
| Silica | 2.0-6.0 |
| Folpet | 10-40 |
| IPBC | 10-40 |
| EASY-SPERSE P-20 (available from | 21.5-3.0 |
| International Specialty Products - a | |
| monobutyl ethylester of poly methyl vinyl | |
| ether/maleic acid)copolymer | |
| and sodium salt and polyvinylpyrrolidone) | |
| Xanthan gum | 0.2-0.6 |

### Process for Example 1

### Part A

IPBC, Folpet, titanium dioxide and silica were mixed together and ground dry for 15 minutes.

### Part B

To a vessel containing 80% of the allotted amount of water the Surfynol® CT 111 grind aid, half of the xanthan gum, and the copolymer of 2-pyrolidone and methoxy ethane sodium salt were added and then ground using a zirconium media mill for 15 minutes. Then, the mixture from Part A containing the biocide was slowly added to the solution from Part B and ground for an additional 1 hour until the Hegmann number was above 6. Then, the rest of the water and the other half of the Xanthan gum were added and ground for an additional 30 minutes until the dispersion was stable and uniform.

A similar process to that for Example 1 was followed for Examples 2-8.

### Example 2

| Component | Wt. % (in range) |
|---|---|
| Water | 44.5-69.35 |
| TiO₂ | 2.0-5.0 |
| Acetylene diols mixture | 0.4-0.9 |
| Silica | 2.0-6.0 |
| Folpet | 5.0-10.0 |
| IPBC | 15.0-30.0 |
| Xanthan gum | 0.2-0.6 |
| EASY-SPERSE P-20 (available from | 1.5-3.0 |
| International Specialty Products - a | |
| monobutyl ethylester of poly methyl vinyl | |
| ether/maleic acid)copolymer | |
| and sodium salt and polyvinylpyrrolidone) | |

### Example 3

| Component | Wt. % (in range) |
|---|---|
| Water | 44.5-69.55 |
| Acetylene diols mixture | 0.4-0.9 |
| EASY-SPERSE P-20 (available from | 1.5-3.0 |
| International Specialty Products - a | |
| monobutyl ethylester of poly methyl vinyl | |
| ether/maleic acid)copolymer | |
| and sodium salt and polyvinylpyrrolidone) | |
| Silica | 2.0-6.0 |
| TiO₂ | 2.0-5.0 |
| IPBC | 5.0-10 |
| Folpet | 15.0-30.0 |
| Xanthan gum | 0.2-0.6 |
| CoatOSil ™ 1211 coating additive (an | 1.0-2.0 |
| organomodified silicone) | |

### Example 4

| Component | Wt. % (in range) |
|---|---|
| Water | 44.5-69.55 |
| Acetylene diols mixture | 0.4-0.9 |
| TiO₂ | 2.0-5.0 |
| Silica | 2.0-6.0 |
| Folpet | 10.0-20.0 |
| IPBC | 10.0-20.0 |
| Xanthan gum | 0.2-0.6 |
| EASY-SPERSE P-20 (available from | 1.5-3.0 |
| International Specialty Products - a | |
| monobutyl ethylester of poly methyl vinyl | |
| ether/maleic acid)copolymer | |
| and sodium salt and polyvinylpyrrolidone) | |
| CoatOSil ™ 1211 coating additive (an | 0.4-0.9 |
| organomodified silicone) | |

### Example 5

| Component | Wt. % (in range) |
|---|---|
| Water | 44.5-68.3 |
| Acetylene diols mixture | 0.4-0.9 |
| poloxamer | 1.0-3.0 |
| Silica | 2.0-6.0 |
| Folpet | 10.0-20.0 |
| IPBC | 10.0-20.0 |
| Xanthan gum | 0.2-0.6 |
| CoatOSil ™ 1211 coating additive (an | 0.3-0.9 |
| organomodified silicone) | |

### Example 6

| Component | Wt. % (in range) |
|---|---|
| Water | 41.5-73.7 |
| Surfynol ® CT111 GRIND AID | 0.4-0.9 |
| Silica | 2.0-6.0 |
| TiO₂ | 2.0-5.0 |
| Folpet | 10.0-20.0 |
| IPBC | 10.0-20.0 |
| CMIT/MIT | 0.5-2.5 |
| Agrimer ® AL29 alkulated vinylpyrrolidone | 0.2-1.0 |
| copolymer | |
| Hydroxypropyl methyl cellulose (HPMC) | 0.2-0.6 |
| Poloxamer | 0.5-1.0 |
| EASY-SPERSE P-20 (available from | 0.5-1.5 |
| International Specialty Products - a monobutyl | |
| ethylester of poly methyl vinyl ether/maleic | |
| acid)copolymer | |
| and sodium salt and polyvinylpyrrolidone) | |

### Example 7

| Component | Wt. % (in range) |
|---|---|
| Water | 31.8-68.4 |
| Surfynol ® CT111 grind aid | 0.4-0.9 |
| Silica | 2.0-6.0 |
| TiO₂ | 2.0-5.0 |
| Folpet | 10.0-20.0 |
| IPBC | 10.0-20.0 |
| Diuron | 5.0-10.0 |
| Dispersby K ® 190 wetting & dispersing | 1.0-4.0 |
| additive | |
| Poloxamer | 0.5-1.0 |
| Dermacryl ® 79 acrylic copolymer | 0.5-1.5 |
| Hydroxypropyl methyl cellulose (HPMC) | 0.2-0.8 |

### Example 8

| Component | Wt. % |
|---|---|
| Water | 68.5 |
| Acetylene diols mixture | 0.7 |
| TiO₂ | 3.0 |
| Silica | 4.0 |
| Folpet | 10.0 |
| IPBC | 10.0 |
| Xanthan gum | 0.5 |
| EASY-SPERSE P-20 (available from | 2.5 |
| International Specialty Products - a | |
| monobutyl ethylester of poly methyl vinyl | |
| ether/maleic acid)copolymer | |
| and sodium salt and polyvinylpyrrolidone) | |
| CoatOSil ™ 1211 coating additive (an | 0.5 |
| organomodified silicone) | |

### Example 9

TABLE 1
Effect of pH on aqueous based Folpet and Folpet/IPBC (%)
dispersion in water

| | pH, After | | | | |
|---|---|---|---|---|---|
| Description | 0 hr | 1 hr. | 1 day | 7 days | 3 weeks |
| Folpet dispersed in water | 11 | 2 | 1.5 | 1.2 | — |
| Folpet modified by amine | 10.9 | 7 | 4.0 | 2.5 | 2.3 |
| dispersed in water | | | | | |
| Folpet and IPBC (1:1) in water | 10.7 | 10.0 | 9.2 | 7.9 | 6.2 |
| Folpet and IPBC (1:1) ground | 10.4 | 10.3 | 9.8 | 8.7 | 8.1 |
| with TiO₂ and kaolin | | | | | |

According to our experimental reports, the more acidic the pH the higher the hydrolysis rate of the Folpet, which is undesirable. The results also indicate that the hydrolysis rate can be reduced considerably, which is desirable, with an increase in the hydrophobic characteristic of the biocide.

While the invention has been described with particular reference to certain embodiments thereof, it will be understood that changes and modifications may be made which are within the skill in the art. Accordingly, it is intended to be bound only by the following claims.

What is claimed is:

1. An aqueous dispersion comprising:
a mixture of a hydrolysis-sensitive biocide, an iodo-derived hydrophobic biocide, and an inert carrier; wherein the iodo-derived hydrophobic biocide forms a complex with the inert carrier and the hydrolysis-sensitive biocide, the complex being dispersible in water; and
water, wherein the complex is dispersed in the water.

2. The aqueous dispersion according to claim 1 further comprising a water-repelling layer coating the complex.

3. The aqueous dispersion according to claim 2 wherein the water-repelling layer includes a film forming polymer.

4. The aqueous dispersion according to claim 1, wherein the hydrolysis-sensitive biocide includes a trihalogenomethylthio phthalimide or an analogue thereof, more particularly, the trihalogenomethylthio phthalimide is N-(trichloromethylthio) phthalimide or N-(dichlororfluoromethyl) phthalimide.

5. The aqueous dispersion according to claim 1, wherein the iodo-derived hydrophobic biocide is iodopropynyl butylcarbamate.

6. The aqueous dispersion according to claim 1, wherein the pH of said aqueous dispersion is at least about 7.0, more particularly at least about 8.0.

7. The aqueous dispersion according to claim 1, wherein the hydrolysis-sensitive biocide and the iodo-derived hydrophobic biocide are particles having a mean particles size of about 0.5 μm to about 10.0 μm, more particularly about 0.5 μm to about 3.0 μm.

8. The aqueous dispersion according to claim 1, wherein said inert carrier is selected from the group consisting of ground natural minerals, ground synthetic minerals, metal oxides, and combinations thereof, more particularly, the inert carrier is selected from the group consisting of clays, talc, chalk, quartz, attapulgite, montmorillonite or diatomacious earth, perlite, zeolite, highly-disperse silica, alumina, titanium dioxide and silicates alone or in combination thereof.

9. The aqueous dispersion according to claim 1, wherein said additive is selected from the group consisting of wetting agent, suspending agent, thickening agent, dispersing agent, preservative, algaecide, silicon fluid and combinations thereof.

10. The aqueous dispersion according claim 9, wherein said wetting agent is selected from the group consisting of alkoxylated acetylenic diols and/or 2,4,7,9-tetramethyl-5-decyne-4,7-diol.

11. The aqueous dispersion according claim 9, wherein said suspending or thickening agent is selected from the group consisting of hydrocolloid gums, cellulose derivatives polysaccharide derivatives, xanthan gum, guar gum, hydroxymethyl cellulose hydroxypropyl methyl cellulose (HPMC), hydroxyproyl ethyl cellulose (HPEC) and/or hydrophobically modified starch to uniformly suspend the finely divided particles.

12. The aqueous dispersion according claim 9, wherein said dispersing agent is selected from the group consisting of copolymer of 2-pyrrolidone and methoxy ethene sodium salt, EO/PO block copolymer, polymers of acrylic and methacrylic acids, C₁₁-C₁₅ secondary ethoxylated alcohol, diols and/or polyether polyols.

13. The aqueous dispersion according to claim 1, wherein the aqueous dispersion is solvent-free.

14. The aqueous dispersion according to claim 1, wherein the weight percent ratio of the hydrolysis-sensitive biocide:iodo-derived hydrophobic biocide is from about 0.1:9.9 to about 9.9:0.1.

15. A process for preparing an aqueous dispersion of hydrolysis-sensitive biocide comprising the steps of:
(a) preparing a dry blend of particles comprising a mixture of a hydrolysis-sensitive biocide, an iodo-derived hydrophobic biocide, and an inert carrier to form a complex;
(b) mixing the complex with water containing at least one of a dispersant, grind aid, and a thickener; and
(c) mechanically processing the mixture from step (b) to yield a desired mean particle size.

16. The process according to claim 15, further comprising coating the complex with a water-repelling agent.

17. The process according to claim 15, wherein the hydrolysis-sensitive biocide includes a trihalogenomethylthio phthalimide or an analogue thereof, more particularly, the trihalogenomethylthio phthalimide is N-(trichloromethylthio) phthalimide or N-(dichlororfluoromethyl) phthalimide.

18. The process according to claim 15, wherein the iodo-derived hydrophobic biocide is iodopropynyl butylcarbamate.

19. The process according to claim 15, wherein the pH of said aqueous dispersion is at least about 7.0, more particularly at least about 8.0

20. The process according to claim 15, wherein mixing the resultant mixture with water includes adding a first aliquot of the total weight percent of the water, the first part comprising at least one of a dispersant, grind aid, and a thickener before step (c) and adding the remaining water as a second aliquot after step (c); and then repeating step (c); and wherein the water includes the thickener with half the thickener in the first aliquot and the other half of the thickener in the second aliquot.

21. The aqueous dispersion according to claim 15, wherein the water further includes an additive selected from the group consisting of wetting agent, suspending agent, preservative, algaecide, silicon fluid and combinations thereof.
